(19) United States
(12) Patent Application Publication
(10) Pub. No.: US 2011/0320931 A1
(43) Pub. Date: Dec. 29, 2011

(54) Method, apparatus and computer program product for handling data of a database for a website

(76) Inventor: Michael Öhman Meurlinger, Stockholm (SE)

(21) Appl. No.: 13/170,871

(22) Filed: Jun. 28, 2011

(30) Foreign Application Priority Data
Jun. 29, 2010 (SE) 1050714-3

(51) Int. Cl. G06F 17/00

(52) U.S. Cl. 715/236

(57) ABSTRACT

A method for handling data of a database for a web page, comprising the steps of:
extracting data from the source database, step 201;
transforming the data into a non-environment dependent transportable data format, step 202; and
automatically generating HTML, CSS and server code from the data item, step 203.
   The invention is also directed to a related apparatus and a computer program product.

### PRIORITY

This application claims priority of Swedish Patent Application No. 1050714-3 filed on 29 Jun. 2010, which is hereby incorporated herein by reference.

### TECHNICAL FIELD

The present invention relates to a method, apparatus and computer program product for handling data of a database for a website.

### BACKGROUND

A web page is typically accessible from a client via a web-server. A client uses a particular type of software, typically a so-called “web browser” (in short referred to as a “browser”) to access a web page.

Typically, a website is a number of web pages having a relation to each other. Typically, websites are written in HTML (Hyper Text Markup Language) and are accessible using the web browser, where the user could browse between the web pages. HTML is used to describe how pages of text, graphics, and other information are organized, formatted, and linked in a website. HTML pages are the standard on the Internet.

Typically, as briefly mentioned above, access of a website is provided by means of a client using a particular web-browser, typically in the form of a local client computer connected to the Internet and running a browser. Typically, the client requests a web page from the web server which handles the request and transmits a response (i. e. the web page) back to the client. A web page could also refer to external files such as images, files describing layout such as CSS files, code files such as JavaScript-files etc.

Basically, there are static and dynamic web pages, of which static web pages do not change every time the page is loaded to the browser. Dynamic pages are referred to as web pages that change dynamically. Dynamic web pages can change every time they are loaded (without a user having to make those changes) and they can change their content based on what the user does, like clicking on some text or an image. One of the most common types of dynamic web pages is the so-called “database driven” type. This means that the web page receives input information from a database (the web page is connected to the database by programming) and inserts that information into the web page each time it is loaded. If the information stored in the database changes, the web page connected to the database will also change accordingly and automatically without human intervention. Typically, dynamic websites use server scripts for generation of web pages. Typically, the data content is handled by a database and is controlled by a so-called “back office”, which is usually an administrative website connected to the public website. Typically, a conventional user cannot freely handle the databases, even though it could be desirable for instance when creating user specific web pages, typically being of commercial type, which is often a requirement today.

To be able to handle a dynamic website there are a number of so-called “platforms” provided. They can be of commercial or “open-source” type. However, all of these offer a framework for handling the dynamic website. To be able to handle a complete website, a number of templates are offered. Typically, this type of solution does not respond to the requirements of a user, in particular if not being a “professional” user. To solve this, typically a consultant specialized in website design must be employed for a specific task. However, a common problem is that there are still problems with high programming skills required in many cases. The basic problem is because the final result, i. e. how the website looks like, cannot be shown at once, i. e. there is no live interaction when programming. The web page is constructed based on a number of data files and is generated by the web server, typically being located remote. Today's most common way is to create the web page by means of coding using particular types of coding editors, which is time consuming and also require high skills as regards programming skills and different standards such as HTML and CSS. Thereafter this code is sent to and executed on a real web-server powering the website.

Another problem is that website designing and implementation often requires a number of competencies such as designers, programmers, database specialists etc. Typically, they use different and often incompatible types of software and tools such as graphical tools for graphical design, data code editors and database tools for handling databases. This typically also requires different types of skills hindering one and the same person to be able to perform all of these skills. Even if one and the same person is skilled within the art, conventional website designing typically requires switching between different tools. This of course is also a drawback.

Since a decade, different systems have been launched intended to provide more user friendly handling of websites including content, design and functionality.

Since the year 2000, web content management system (WCMS, or more often CMS) are well-known. CMS is a content management system provided for collaborative handling of content for a website. The website is edited by means of an interface, typically not requiring editing code, but a more user friendly WYSIWYG-editing is used instead.

In CMS, a computer system controls the technical features of the content, provides advanced features and automatic tasks, which would otherwise require substantial redundant manual work. Typically, the content is stored in a remote database, where also settings and rules for handling the content are stored. Displaying of content in the database is powered by computer programs, often referred to as scripts including PHP, Perl or Java.

Typically, all of these prior art solutions for website design operate in off-line mode.

But, there are a number of drawbacks using today's solutions, in particular as regards non-live interaction using complicated code editors operating in an off-line mode.

There is a need to be able to handle web pages in an easier more user friendly way using only one master tool for all or at least most of the tasks.

There is also a need for a conventional user, typically not being a skilled programmer, to be able to control the website as regards content, design and functionality by him and by means of a master tool.

### SUMMARY OF THE INVENTION

The present invention enables working on-line, in real-time without delay.

An aspect of the present invention is to provide a method for handling data of a database for a web page, said method comprising the steps of:
extracting data from a source database;
transforming the data into a non-environment dependent transportable data format;
and automatically generating code for real-time-editing such as HTML, CSS and server code from the data format.

Herein, the term “handling” typically includes editing.

Herein, the term “data format” includes an item or object including a tree structures, or a list, which represents a data structure. The data format can also include a plurality of objects.

Herein, the term “non-environment dependent transportable” means that the data format can be transported in any environment.

Herein, the term “real-time” includes live-editing. In particular real-time editing provides website designing in a real-time environment.

Herein, the term “data” is referred to data containing every type of data such as data content, high level code, binary image data, one or more than one data file.

In this way there is provided a method for extracting content from a database and transforming this data into a transportable data format for instance as an object. The data is transformed into a data format which is not dependent on environment. And can be transported to any desirable destination, or to a plurality of destinations. The data format can be used together with an automatic data conversion tool for generating HTML, CSS and server code, typically after having been edited. The advantage with transforming data to a transport transparent object is that the object can be used in all environments including a design tool such as the one manufactured and sold under the trademark “Sitoo®”, an administrative website, services and in a server powering the actual web page.

According to another aspect of the present invention, there is provided an apparatus for handling data of a database for a web page. The apparatus comprises:
a data extractor for extracting content from a source database;
a transformer for transforming the data into a non-environment dependent transportable data format; and
a generator for generating code for real-time-editing such as HTML, CSS and server code from the data format.

Typically, the extraction of data could be based on mapping tables, typically such that data is extracted automatically by means of a mapping table.

Typically, the data is transformed into an object, in particular a so-called item.

Typically, the object is created such that it represents a list.

Typically, the object is created such that it represents a tree structure.

Typically, data is handled as code and/or a service for further transport to other systems using the same item.

Typically, the step of generating data uses a parameterized functional block operating on data for generating HTML, CSS and server code.

Typically, the parameterized functional block comprises a user interface.

Typically, one or more parameterized functional blocks is/are arranged into a component such that it/they can be selected depending on functionality of the component.

Typically, the component(s) is/are presented as an image and is selected graphically.

Typically, the component(s) is/are centrally located and is/are distributed online or offline.

According to a second aspect of the present invention there is provided an apparatus for handling data of a database for a web page, said apparatus comprising:
a data extractor for extracting data from a source database;
a transformer for transforming the data into a non-environment dependent transportable data format; and optionally
a generator for generating code for real-time editing such as HTML, CSS and server code from the transformed data format.

There is also provided a computer program product comprising in a computer executable code means, when loaded into the computer to perform the method or implement the apparatus.

### BRIEF DESCRIPTION OF THE DRAWINGS

The features and advantages of the present invention as described and additional ones will become further apparent from the following detailed description and the accompanying drawings, of which:

FIG. 1 illustrates a system for handling data of database for a web page of a website according to an embodiment of the present invention;

FIG. 2 illustrates a flow chart of a method for handling data of a website according to an embodiment of the present invention;

### DETAILED DESCRIPTION OF THE INVENTION

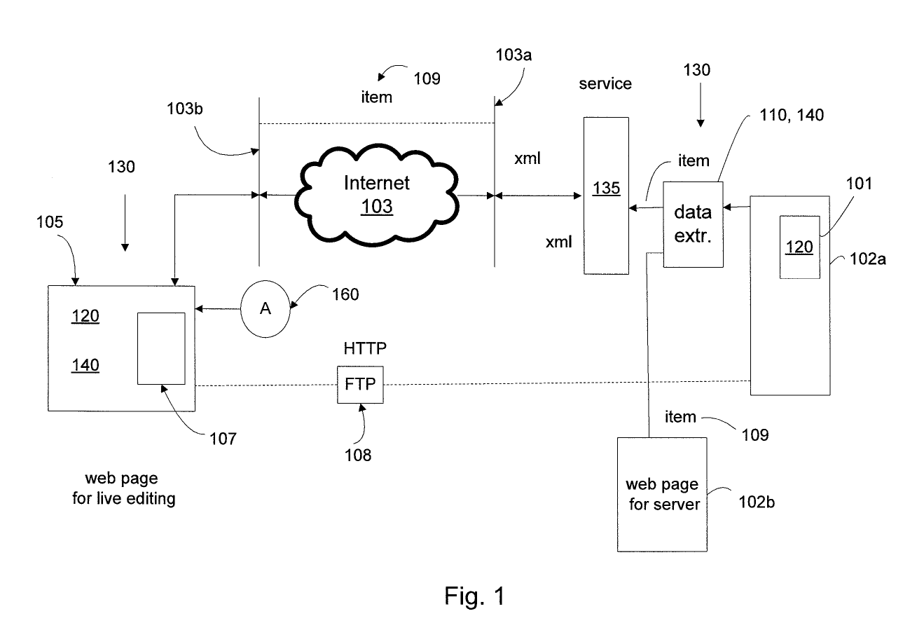

Now is first referred to FIG. 1 illustrating a system 100 for handling data of a database for web pages of a website according to an embodiment of the present invention. The system 100 comprises a database 101 for (powering) a web-server 102a powering a web page 102b of the server 102a, connected to a data communications network 103, herein the Internet. The server 102a has a first communications interface 103a to a first side of the network 103. On a second side of the network 103 there is provided a client (client computer running an application program, often referred to as an “app”) 105 connected and communicating via a second interface 103b of the intervening network 103, located between the first and second interfaces 103a, 103b. The client 105 herein being an external computer arranged to be connected to the server 102a through the communication interfaces 103a, 103b and via the intervening network 103. In this way, the client 105 could exchange information with the database 101, such that the database 101 is accessible, also for editing, for the client 105.

The client 105 uses an apparatus 130 for handling data 120 of the database 101 for a editable web page 107 to be edited live locally on the client 105. The apparatus for handling data 130 also comprises means (110, 140) for extracting data and transforming the same into a transport independent format a so-called “item” 109. These means 110, 140 can be provided separated from the apparatus 130. As is evident from FIG. 1 the item 109 can be transmitted in any direction independent of environment, for instance to the client 105 for live editing as well as being transmitted for powering the web page 102b of the server 102a without editing. The apparatus 130 for handling data is typically provided in a design tool for designing web pages. An example of such a design tool is manufactured under the trademark “Sitoo®”. The apparatus 130 comprises a data extractor 110 for extracting data 120 from a source database 101, a transformer 140 for transforming the extracted data 120 into a transportable data format, such as an object, in particular an item, 109 and a data conversion tool 160 for generating code HTTP, FTP for real-time editing of editable web pages 107 such as HTML, CSS and server code from the data edited locally in the client. The code is transmitted directly to the server 102a. In this way, real-time editing of data is possible. The user can see what the web page 107 (or of course the entire website made up of a plurality of web pages) looks like, at once, i. e. there is live interaction when editing. This is not possible by means of conventional technology.

Typically, the web pages 102b are written in HTML (Hyper Text Markup Language) and are accessible using a conventional web browser, where a user by means of the client 105 could browse between the web pages 107. Typically, HTML has been used to design the website 102b (a number of interconnected web pages) that describes how pages of text, graphics, and other information are organized, formatted, and linked in a website. FIG. 1 also illustrates how the client 105 has access to the hosting provider's server, i. e. the web-server 102 by means of using a File Transfer protocol (FTP) and HTTP-protocol. The files for the website 107 are transferred to the corresponding web-server 102 providing the website 107 using FTP 108. Of course, the invention is by no means limited to the particular type of network (the Internet) and the protocols described FTP and HTTP, since these are only examples.

In FIG. 1 the data extractor 110 and the transformer 140 is illustrated separated from the client 105 for a better understanding of the present invention. Part of the apparatus can also be implemented by, or additionally comprise a service means 135, which is schematically illustrated as a separate block, separated from the client 105. Typically, the data conversion tool 160 is provided in, or linked to, the client 105 and separated from the data extractor 110 and the transformer 140 as is evident from FIG. 1.

All of these functional means and their implementation 110, 140, and 160 are obvious for a person skilled in the art to design and implement for instance by programming once the solution according to the invention is presented. Because of that, they or their implementation will not be described in more detail, but only schematically.

In this way there is provided a method for extracting content from a database and transforming this data into a transportable format for instance as an object. The data format can be used together with an automatic data conversion tool for generating HTML, CSS and server code. The advantage with transforming data to a transport transparent object is that the object can be used in all environments including a design tool such as the one manufactured and sold under the trademark “Sitoo®”, an administrative website, services and the final web page.

The invention provides live editing locally.

A particular aspect for creating a designable transform of an item to code is to use the automatic data conversion tool 160. The automatic data conversion tool 160 typically comprises a parameter block as well as a functional program language for transforming the object to code. The parameter block is used for exposing users to possible settings controlling generation of code. In this way, it is easy for the user to get in control over the design in real-time. The functional programming language can easy provide complex transforms of item to code.

A particular advantage of the present invention is that a live set-up for a web page design tool is provided. In this way, information (data) is extracted dynamically in real-time from the database and code is generated automatically by the web page design tool. The user sees the resulting web page directly during editing using the web page design tool, i. e. one master tool. In this way, it is possible to design websites at high speed without high programming skills. This is a great advantage compared to prior art technology working off-line.

In this way, by means of the present invention is possible for a user to work on-line in real-time when editing using his own computer. This is different compared to prior art solutions require using another computer as well.

In this way, website designing will be much faster and user-friendly. For instance, by means of the present invention it is easy to re-design a website compared to conventional technology because there is only one user interface (tool) instead of several required. The appearance of the user interface (tool) is very logical to a user. The inventive tool could typically be regarded as a “master tool” providing all functions, such as updating links to other pages, menus etc, at the same time.

The object can be used together with an automatic data conversion tool for generating HTML, CSS and server side code. The advantage with transforming data to a transport transparent object is that the object can be used in all environments including a design tool such as the one manufactured and sold under the trademark “Sitoo”, the administrative website, services and the final web page.

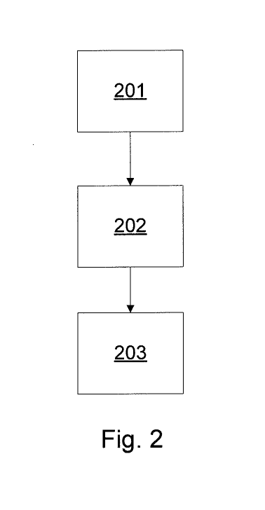

Now is referred to FIG. 2 illustrating a flow chart of a method for handling data of a website according to an embodiment of the present invention.

In a first step, a source file is extracted from a source database, step 201. Then in a second step, data is transformed into a transportable data format such as an object, in particular a “switem”, step 202, followed by automatically generating HTML, CSS and server code from the data item, step 203.

The last step, step 203 is optional and could in some cases be left out.

Typically, the object is created such that it represents a list.

Typically, the object is created such that it represents a tree structure.

Typically, data is handled as code and/or a service for further transport to other systems using the same switem.

Optionally, the step of generating data uses a parameterized functional block operating on data for generating server code, step 202.

The parameterized functional block can comprise a user interface.

Optionally, one or more parameterized functional blocks is/are arranged into a component such that it/they can be selected depending on functionality of the component, step 207.

Optionally, the component(s) can be presented as an image and is selected graphically.

By means of the components comprising the means for generating server code, a user can easily set a component, select which means for generating server code will be used and finally configure exactly how the design will look like. All of this is shown in the same way as the final result, providing it easy to fast build a desired design. The means for generating server code can be coupled directly to raw data.

The component may also control how data is to be filled in by means of filter(s) or sorting means (of which both can be set on the component).

The component as well as the code generator can be centrally located and distributed online and/or offline. For instance a website can contain a number of such generators or components which are down-loadable to be used for handling dynamic web pages.

### Special Features:

The invention can also be embodied in the form of an application store, where a user can buy an application and activate a feature such as a web-shop. Typically, all of this is provided by means of a one-click solution. The application store provides one or more applications in the form of one or more platforms for operating different features.

Typically, the application store is provided in one tool, where the content thereof is displayed by means of a web-browser. The application store is typically operating as WYSIWYG providing codes such as script codes or conventional HTML or CSS codes.

The method and apparatus could be completely or partly implemented by means of software, typically in the form of a computer program product comprising computer code means stored on a data carrier or being directly loadable into a computer.

In this way, a user could easily and fast handle website layout including all web pages simultaneously operating from only one user interface or using one design tool.

The client 105 could for instance be a local client computer, a work station, a terminal, a handheld communication device such as a PDA, or other handheld PC device, or a digital electronic storage. Thus, the term, “client” should be non-limited to a computer only.

The foregoing detailed description is intended to illustrate and provide easier understanding of the invention, and should not be construed as limitations. Alternative embodiments will become apparent to those skilled in the art without departing from the spirit and scope of the present invention.

1. A method for handling data of a database for a web page, said method comprising the steps of:
extracting data from the source database;
transforming the data into a non-environment dependent transportable data format; and
using a computer to automatically generate code for real-time-editing such as HTML, CSS and server code from the data item.

2. The method according to claim 1, wherein:
the data is transformed into an object, in particular a “switem”, step 202.

3. The method according to claim 1, wherein data is extracted automatically by means of a mapping table, step 201.

4. The method according to claim 2, wherein the object is created such that it represents a list.

5. The method according to claim 4, wherein the object is created such that it represents a tree structure.

6. The method according to claim 2, wherein data is handled as code and/or a service for further transport to other systems using the same switem.

7. The method according to claim 1, comprising the step of generating data using a parameterized functional block operating on data for generating server code, step 202.

8. The method according to claim 7, wherein the parameterized functional block comprises a user interface.

9. The method according to claim 8, wherein one or more parameterized functional blocks is/are arranged into a component such that it/they can be selected depending on functionality of the component, step 207.

10. The method according to claim 9, wherein the component(s) is/are presented as an image and is selected graphically.

11. The method according to claim 10, wherein the component(s) is/are centrally located and is/are distributed online or offline.

12. An apparatus (130) for handling data of a database for a web page, said apparatus (130) comprising:
a data extractor (110) for extracting data (120) from a source database (101);
a transformer (140) for transforming the data (120) into a non-environment dependent transportable data format (109); and optionally
a generator for generating HTML, CSS and server code from the transformed data format (109).

13. A computer program product comprising executable code stored in a tangible medium, which is operable in a computer to perform the method according to claim 1.
